(19) United States
(12) Patent Application Publication
(10) Pub. No.: US 2010/0079481 A1
(43) Pub. Date: Apr. 1, 2010

(54) METHOD AND SYSTEM FOR MARKING SCENES AND IMAGES OF SCENES WITH OPTICAL TAGS

(76) Inventors: Li Zhang, Madison, WI (US); Neesha Subramaniam, Palo Alto, CA (US); Robert Lin, Bozeman, MT (US); Shree K. Nayar, New York, NY (US); Ramesh Raskar, Cambridge, MA (US)

Correspondence Address: MITSUBISHI ELECTRIC RESEARCH LABORATORIES, INC., 201 BROADWAY, 8TH FLOOR, CAMBRIDGE, MA, 02139, US

(21) Appl. No.: 12/524,705

(22) PCT Filed: Jan. 21, 2008
(86) PCT No.: PCT/US08/51555

§ 371 Date: Jul. 27, 2009

Related U.S. Application Data
(60) Provisional application No. 60/897,348, filed on Jan. 25, 2007.

(51) Int. Cl. G09G 5/02

(52) U.S. Cl. 345/595; 345/589; 345/629; 348/661; 382/100

(57) ABSTRACT

A method and system marks a scene and images acquired of the scene with tags. A set of tags is projected into a scene while modulating an intensity of each tag according to a unique temporally varying code. Each tag is projected as an infrared signal at a known location in the scene. Sequences of infrared and color images are acquired of the scene while performing the projecting and the modulating. A subset of the tags is detected in the sequence of infrared images. Then, the sequence of color image is displayed while marking a location of each detected tag in the displayed sequence of color images, in which the marked location of the detected tag corresponds to the known location of the tag in the scene.

### RELATED APPLICATION

This application claims priority to U.S. Provisional Application No. 60/897,348, “Capturing Photos and Videos with Tagged Pixels,” filed on Jan. 25, 2007 by Zhang et al.

### FIELD OF THE INVENTION

This invention relates generally to image acquisition and rendering, and more particularly to marking a scene with optical tags while acquiring images of the scene so objects in the scene can be located and identified in the acquired images.

### BACKGROUND OF THE INVENTION

Digital cameras have increased the number of images that are acquired. Therefore, there is a greater need to automatically and efficiently organize and search images. Tags can be placed in a scene to facilitate image organization and searching (browsing).

The tags can be physical tags that are attached to objects in the scene. Those tags can use passive patterns and active beacons. Passive fiducial patterns include machine readable barcodes. Traditional barcodes require the use of an optical scanner. Cameras in mobile telephones, i.e., phone cameras, can also acquire Barcodes. While those codes support pose—invariant object detection, the tags can only be read one at a time. The resolution and dynamic range of phone cameras do not permit simultaneous detection of multiple tags/objects.

Passive fiducial patterns are also used in augmented reality (AR) applications. In those applications, multiple tags are placed in the scene to identify objects and to estimate a pose (3D location and 3D orientation) of the camera. To deal with the limits of camera resolution, most. AR systems use 2D patterns that are much simpler than barcodes. Those patterns often have clear, detectable borders to aid camera pose estimation.

To reduce the requirements on camera resolution and viewing distance, active blinking LEDs can be used as tags. Each tag emits a light pattern with a unique code. As a disadvantage, physical tags require a medication of the scene, and change the appearance of the scene. Active tags also require a power source.

Radio frequency identification (RFID) tags can also be used to determine the presence of an object in a scene. However, RFID tags do not reveal the location of objects. Alternatively, a photosensor and photoemitter can be placed in the scene. The photo sensor/emitter responds spatially and temporally coded light patterns.

To augment the information displayed by a projector, one can project both visible and infrared (IR) images onto a display screen. When a user finds interesting information in the visible light image, the user can then use a camera to retrieve additional information displayed in the IR image.

### SUMMARY OF THE INVENTION

The embodiments of the invention provide a system and method for acquiring images of a tagged scene. The invention projects temporally coded infrared (IR) tags into a scene at known locations. In IR images acquired of the scene, the tags appear as blinking dots. The tags are invisible to the human eye or a visible light camera. Associated with each tag is an identity a unique temporal code, a 3D scene location, and a description.

The tags can be detected in infrared images acquire of the scene. At the same time, color images can be acquired of the scene. The known locations of the tag in the infrared images can be correlated to locations in the color images, after the camera pose is determined. The tags can than be superimposed on the color images when they are displayed, along with additional information that identifies and describes objects at the locations.

An interactive user interface can be used to browse a collection of tagged images according to the detected tags. The temporally coded tags can also be detected and tracked in the presence of camera motion.

### BRIEF DESCRIPTION OF THE DRAWINGS

FIG. 1A is a block diagram of a system for tagging a scene according to the invention;

FIG. 1B is a block diagram of a method for tagging a scene according to embodiments of the invention;

FIG. 2 is a table of temporal codes according to embodiments of the invention;

FIG. 3 is an image of a tagged scene according to embodiments of the invention;

FIG. 4 is an infrared image of the scene of FIG. 3 according to embodiments of the invention;

FIG. 5 is an image of the scene of FIG. 3 superimposed with the tags of FIG. 4 according to embodiments of the invention;

FIG. 6A is an image of a scene with tags according to embodiments of the invention;

FIG. 6B is an image with infrared patches according to embodiments of the invention;

FIG. 6C is an image with tags according to embodiments of the invention;

FIG. 6D is a sequence of infrared images with connected tags according to embodiments of the invention;

FIG. 7 is a graph of 3D locations according to embodiments of the invention;

FIG. 8 is a user interface according to embodiments of the invention; and

FIGS. 9A and 9B are images of relocated objects in a scene tagged according to the embodiments of the invention.

### DETAILED DESCRIPTION OF THE PREFERRED EMBODIMENT

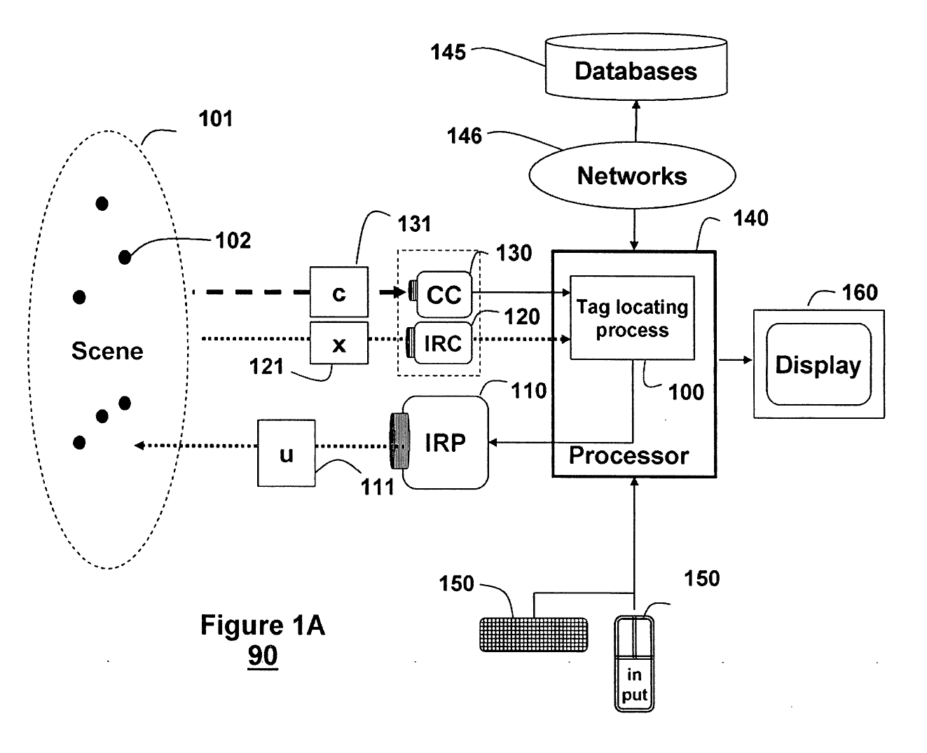

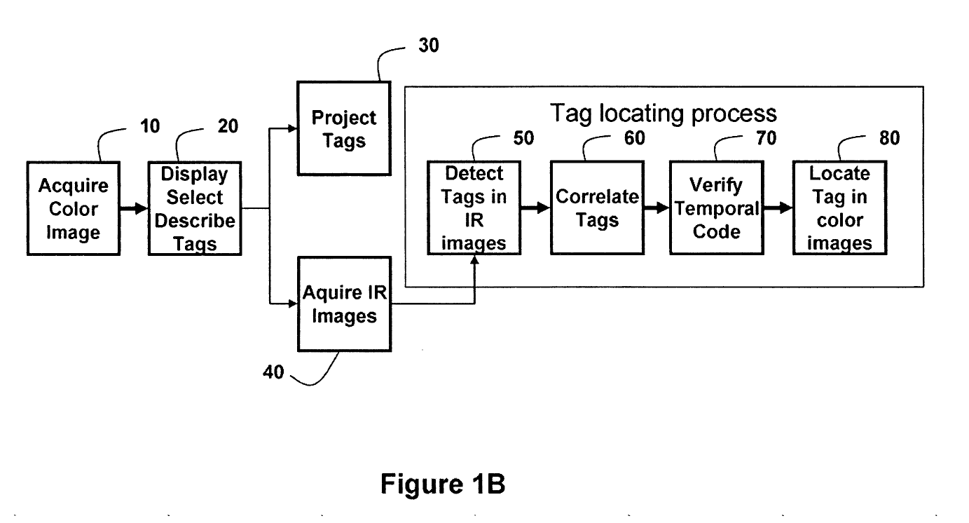

As shown in FIGS. 1A and 1B, the embodiments of our invention provide a system 90 and method 100 for marking a scene 101 with a set of infrared (IR) tags 102. The tags are projected using infrared signals. The tags appear in infrared images acquired of the scene. Otherwise, the IR tags are not visible in the scene or in color images acquired of the scene. The tags can be used for object identification and location. The tags enable the automatic organization and searching of color images acquired of the scene and stored in a database 145 accessible via, e.g., a network 146.

The system includes an infrared (IRP) projector 110, an IR camera (IRC) 120, a color (user) camera (CC) 130, and a processor 140.

The processor can be connected to input devices 150 and output devices 160, e.g. mouse, keyboard, display unit, memory, databases (DB), and networks such as the Web and the Internet. The processor performs a tag locating process 100 as described below. In a preferred embodiment, the optical centers of the cameras are co-located. Exact co-location can be achieved by using mirrors and/or beam splitters, not shown.

However, a user of the system can also take color images of the scene from arbitrary points of view. That is, the color camera is handheld and mobile. In this case, the locations of some of the tags may be occluded in the color images, and only a subset of the tags is observed. However, we can display occluded and out-of-view tags as described below. Thus, the detected subset of tags can include some or all of the projected tags.

It should be noted that images can be acquired by a hybrid camera, which acquires both IR and color images. In this case, only a single camera is needed. The cameras can also be video cameras acquiring sequences of images (frames). The projector can also be in the form of an infrared or far infrared laser. This can increase the range of the projector, and decrease the size of the projected tags, and make the detection less sensitive to ambient heat.

The projector projects IR tags 102 into the scene as an IR image u 111, while the cameras acquire respective IR images x 121 and color images 131, which are processed 100 by the method according to the embodiments of the invention, as describe below.

Projected Tags

In the preferred embodiment, the tags are temporally modulated infrared tags. Temporal coding projects a “blinking” pattern according to a unique temporal sequence. In our case, each tag is a small dot, about the size of a pixel in an acquired image. Because the tag is much smaller than comparable spatial pattern, it is not as sensitive to surface curvature and varied albedo. The dot-sized tag does not impose strict requirements on camera resolution and viewing distance. The temporal coding does require that a sequence of IR images needs to be acquired. We use two-level binary coding. The projected tags have only two states: ON(1) and OFF(0).

Temporal Binary Code Sequence

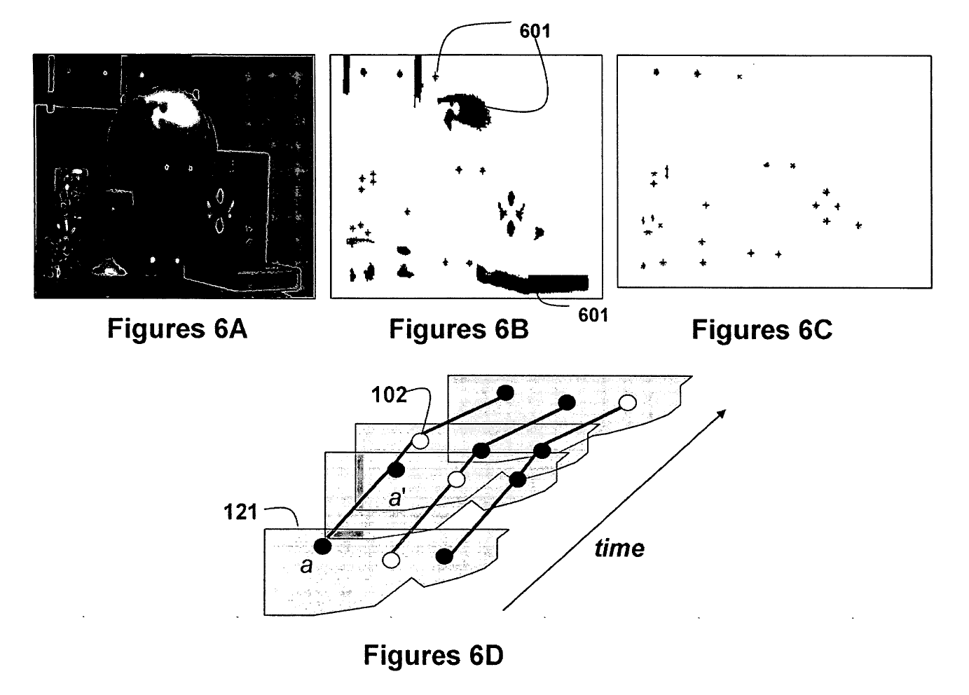

Each temporal code is an L-bit binary sequence. Our codes form a subset of the complete set of binary sequences. We construct this subset based on the following considerations. Each tag has a unique temporal code. In order to allow motion, we track tags over time in a sequence of L frames, see FIG. 6D. We avoid binary sequences with a large number of consecutive zeros and ones. This is because a high intensity spot, e.g., a highlight in the IR spectrum, may be mistaken as a tag that is “ON.” Limiting the maximum number of consecutive zeroes and ones forces a tag to “blink,” which disambiguates the tag from bright spots in the scene. Because the codes are projected periodically and the camera does not know the starting bit of the code, all circular shifts of the temporal code, e.g., 0001010, 0010100, and 0001010, represent the identical temporal code. A major advantage of our binary coding is that we can increase the gain of the IR camera to detect tags on dark (cooler) surfaces. Thus, the tags can still be detected as long as the surface does not saturate.

The maximum number of permissible consecutive zeros and ones are M and N, respectively. For a reasonable value of L, this number can be found by searching through all possible 2^{L} code sequences.

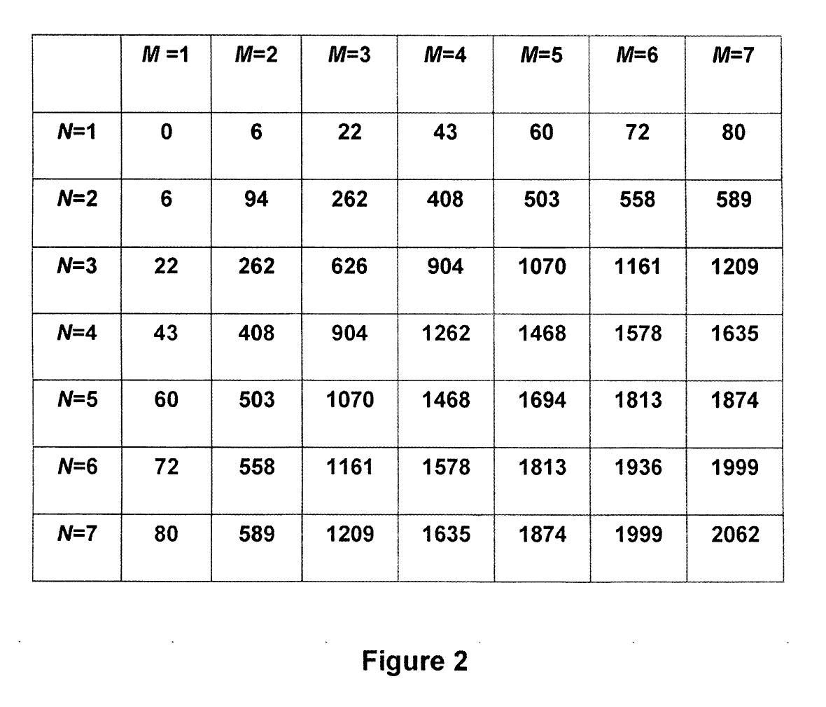

FIG. 2 shows the number of usable 15-bit codes for different values of M and N. In our implementation, we have used L=15 and M=N=4. A usable code represents all circular shifts of itself.

Tagging a Three-Dimensional Scene

The method according to one embodiment of the invention is shown in FIG. 1B, and FIGS. 2-6. We acquire 10 an initial color image of the entire scene using the color camera. We display 20 the display device 160, and select 30 scene points to be tagged by using the input device 150, e.g., a mouse.

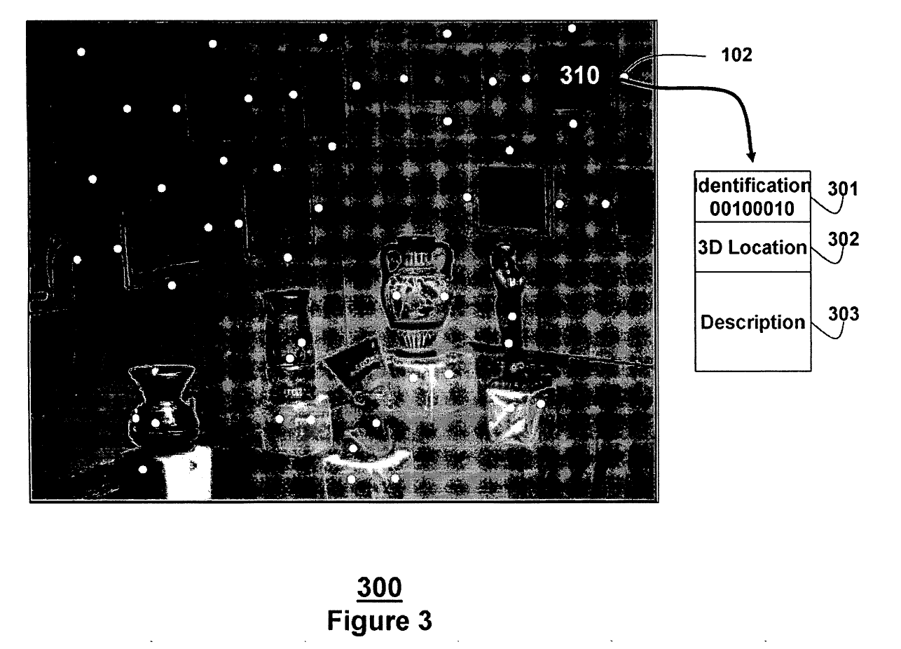

FIG. 3 shows an image 300 and selected tags 102. Each tag is associated with a unique identification 301, i.e., the unique temporal sequence as described above. The tag is also associated with a known 3D location 302 and an object description 303. The description describes the object 310 on which the tag 102 is projected. At least six tags with known 3D locations are required to obtain the 3D pose of the IR camera. During this “authoring” phase, the cameras are at fixed locations. Therefore, we only need to estimate the pose once. However, during operation of the system, the pose of the cameras can change as the user moves around. Therefore, we need to estimate the pose for every image in the sequence.

Acquiring Tagged Images.

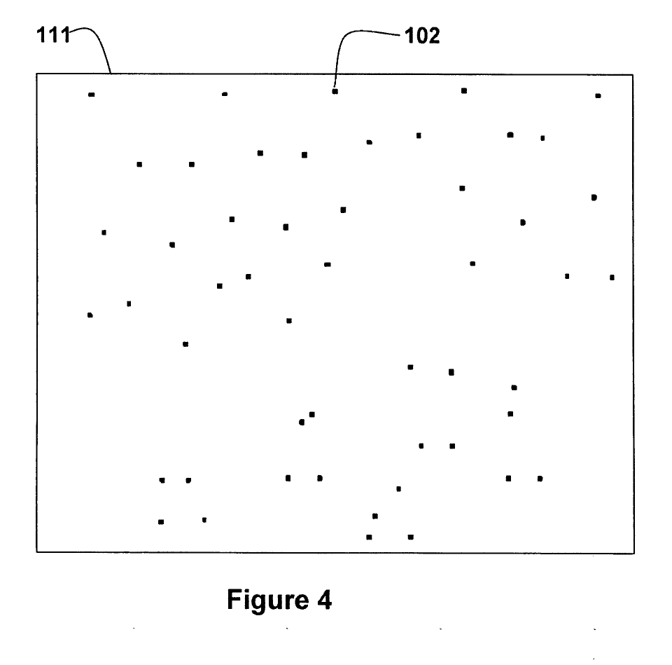

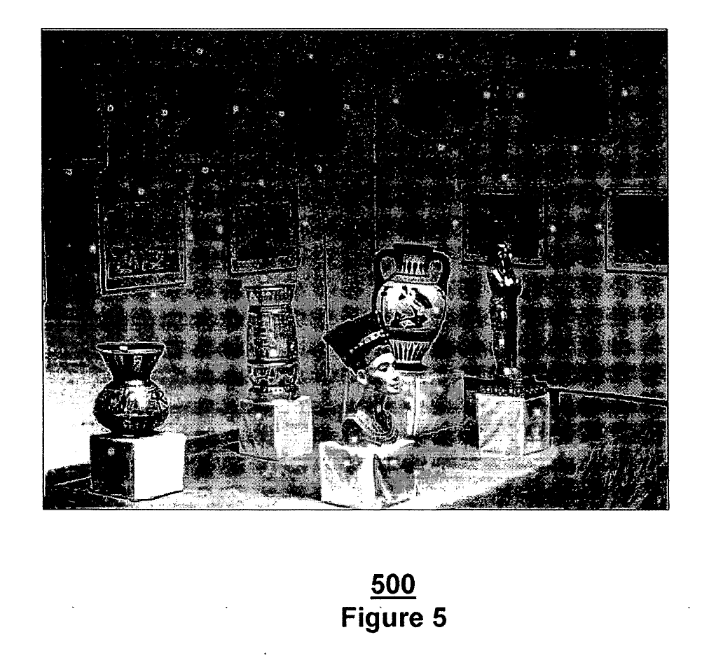

We project 30 the tags, selected as described above, into the scene using the IR projector. FIG. 4 shows an example projected. IR image 111. At the same time, we acquire 40 color and IR images, see FIGS. 5 and 6A for example acquired images superimposed with the tags. If the camera is static, a single color image is sufficient, otherwise a sequence of color images needs to be acquired. The number of images in the IR image sequence, e.g., fifteen, is sufficient to span the duration of the temporal code. Because our codes are circular shifts of each other, the acquisition of the IR images can begin at an arbitrary time.

Tag Locating

Our tag locating process 100 has the following steps.

Tag Detection

We detect 50 a subset of tags independently in each IR image of the sequence. Each projected tag 102 should produce a local intensity peak in the acquired IR images. However, there may be ambient IR radiation in the scene. Therefore, we detect regions 601 in each image that have relatively large intensity values. This can be done by thresholding the intensity values. FIG. 6B shows regions 601.

Notice that some of the regions are large. We compare an area of each region to an area threshold, and remove the region if the area is greater than the threshold. The threshold can be about the size of the tag, e.g., one pixels. The remaining regions are candidate tags, see FIG. 6C.

Temporally Correlating Tags

As shown in FIG. 6D, we correlate 60 the candidate tags over the sequence of IR images 121 to recover the unique temporal code for each tag. Specifically, for each candidate tag a in a current frame, we find a nearest candidate tags a′ in a next frame. If a distance between the candidate tags a and a′ is less than a predetermined distance threshold, we ‘connect’ these two tags and assume the candidates are associated with the same tag. The threshold is used to account for noise in the tag location. This temporal “connect the dots” process is shown in FIG. 6D.

If the candidate tag a does have an associated nearby tag in the next frame, we set its code bit to ‘1 ’ in the next frame. If the candidate tag a does not have an associated nearby tag in the next frame, we set its code bit to ‘0 ’ in the next frame. If the next frame includes a candidate tag b that does not have a connected tag in the previous frame, we include it as a new tag with code bit ‘0 ’ in the previous frame. We apply this procedure to all images in the IR sequence to obtain the temporal code for each tag.

Code Verification

In this step, we verify 70 that the candidate tags are actually projected tags. Therefore, we eliminate spurious tags by ensuring that each detected temporal code satisfies the constraint that each code cannot have more than M consecutive zeros and N consecutive ones, and the unique code is one assigned to our tags.

Tag Location

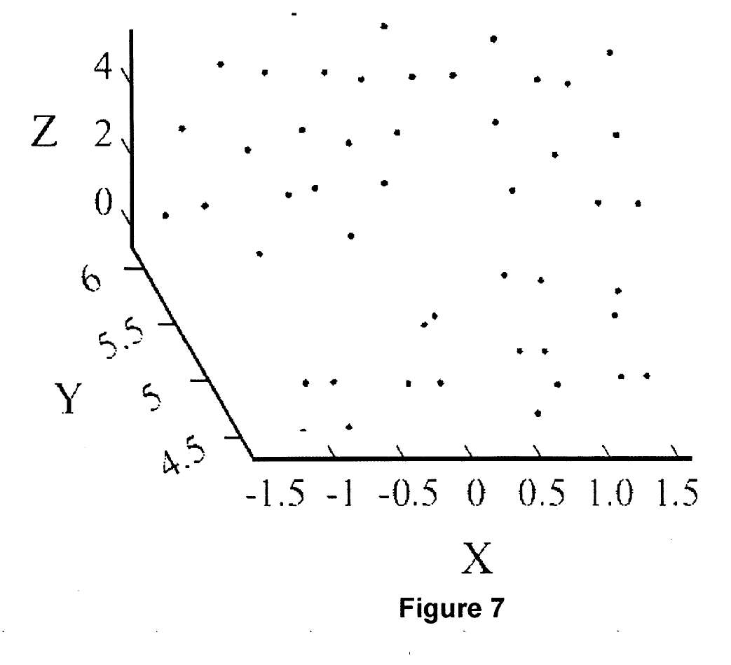

As shown in FIG. 7, the 3D coordinates of the uniquely identified tags can be determined 80 as follows. The location of tag g in the IR image x is [x_{g}, y_{g}]^{T}, where T is the transpose operator. The known location of tag is [u_{g}, v_{g}] in the projected IR image u. Given all locations x_{g} and u_{g}, we determine the fundamental matrix F between the projector and the IR camera, using the well known 8-point linear method. The matrix F represents the epipolar geometry of the images. It is a 3×3, rank-two homogeneous matrix. It has seven degrees of freedom because it is defined up to a scale and its determinant is zero. Notice that the matrix F is completely defined by pixel correspondences. The intrinsic parameters of the cameras are not needed.

Then, we calibrate the IR camera with the projector according to the matrix F. After the calibration, we obtain two 3×3 intrinsic matrices Kₚ and K_{c} for the projector and the IR camera, respectively. These two matrices relate image points in the two images to their lines of sight, in 3D space. Using the matrices Kₚ, K_{c}, and F, we can estimate the rotation R and the translation t of the camera with respect to the projector, by applying a single valued decomposition (SVD) to the essential matrix E=K_{c}^{T}FKₚ. The essential matrix E has only five degrees of freedom. The rotation matrix R and the translation t have three degrees of freedom, but there is an overall scale ambiguity. The essential matrix is also a homogeneous quantity. The reduced number of degrees of freedom translates into extra constraints that are satisfied by an essential matrix, compared with a fundamental matrix. The rotation and translation enables us to estimate the 3D location for each tag gin the IR images by finding the intersection of its lines of sights from the projector and the camera.

Synchronization

It may be impractical to synchronize the IR projector and the IR camera. Therefore, we operate the IR camera at a faster frame rate than the projector, e.g., 30 fps and 15 fps, respectively. This avoids temporal aliasing. The input images are partitioned into two sets. One set has odd images and the other set has even images.

If the IR camera and the IR projector are synchronized, then both sets are identical in terms of the clarity of the projected tags. When the two devices are not synchronized, then one of the two (odd/even) sets has clear images of the projected tags, and the other set may contain ghosting effects due to intra-frame transitions. For all pixels where candidate patches have been detected during the detecting step 50, we determine intensity variances for each of the two image sets. The set without intra-frame transitions has a greater intensity variance and is used in the correlation step 60.

Detecting Occluded and Out-of-View Tags

The tags that are detected are visible tags. From these tags, we can determine the pose of the IR camera because the 3D coordinates of all tags in the scene are known. Because the IR and color camera are co-located, the pose of the color camera is also known. Specifically, the location of a tag g in the IR image is x_{g}=[x_{g}, y_{g}]^{T}, and its 3D scene coordinates are X_{g}=[X_{g}, Y_{g}, Zg]^{T}. Given all x_{g} and X_{g}, we determine the 3×4 camera projection matrix P=[pᵢⱼ] using the 6-point linear process. The matrix P maps the tags from the 3D scene to the 2D image as

$$x = \frac{{p}_{11} X + {p}_{12} Y + {p}_{13} Z + {p}_{14}}{{p}_{31} X + {p}_{32} Y + {p}_{33} Z + {p}_{34}} , \\ y = \frac{{p}_{21} X + {p}_{22} Y + {p}_{23} Z + {p}_{24}}{{p}_{31} X + {p}_{32} Y + {p}_{33} Z + {p}_{34}} .$$

Recall, the color camera can have an arbitrary point of view. Therefore, the projection matrix P enables us to project other tags that are not ‘visible’ in the color image. In this case, not visible meaning, the tags are hidden behind other objects for certain some of view. If these tags should be in the field of view of the color image, then these tags are occluded tags. If the tags are outside the field of view of the image, then the tags are out-of-view tags. The three tag types, visible, occluded, and out-of-view can have different colors when the tags are superimposed on the displayed color image.

Browsing Tagged Photos

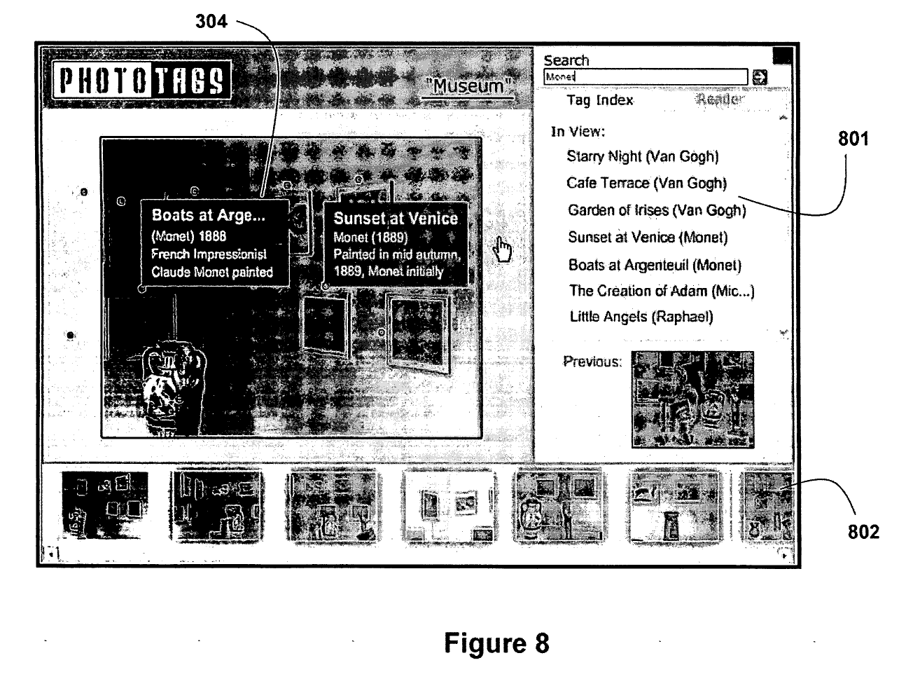

As shown in FIG. 8, we also provide an interactive user interface for browsing collections of tagged images. The interface can operate in a network environment, such as the Internet shown in FIG. 1A. The interface displays images and the locations of the detected tags are marked in the displayed images. Descriptions of tagged objects can also be displayed. When the user selects an image, the interface displays the image and marks all tags in the image. The visible tags are shown in green, while the occluded and out-of-view tags are shown in red and blue, respectively.

FIG. 8 shows a list 801 of tagged objects. A slider panel 802 for all images appears at the bottom. When the user selects a tag, the description 303 is displayed. The interface can also display the best available view of the object, e.g., the image in which the object appears closest to the center of the image.

Camera Motion

If the camera moves, then the tags in the sequence of IR images appear to move over time. If the motion is large, then we need an accurate detection method.

We first consider the case where the projector and the camera are synchronized. The lack of the synchronization is resolved as before. We have an L-frame color video sequence {Cₜ}, and an L-frame IR video sequence {Iₜ }, where t=1, 2, . . . , L. These two videos are acquired from the same viewpoints. Recall, the optical centers of the color and IR cameras are co-located. We locate the tags in each color image Cₜ using the corresponding IR sequence {Iₜ }.

The detection step 50 and the verification step 70 are described above. However, to correlate ‘moving’ tags in the video, we need to determine camera motion between temporally adjacent frames. This motion is difficult to estimate using only the IR images because most of the pixels are ‘dark’, and the temporally coded tags appear and disappear in an unpredictable manner, particularly when the cameras are moving.

However, because the IR video and color video share the same optical center, we can use the color video for motion estimation. The precise motion of the tags is hard to determine because the motion depends on scene geometry, which is unknown even for the tagged location until the tags are detected and located.

Because the tag motion is only used to aid tag correlation, we use a homography transformation to approximate tag motions between temporally adjacent frames. Using homography to approximate motion between two images is a well-known in computer vision, often referred to as the “plane+parallax” method. However, the prior art methods primarily deal with color images, and not blinking tags in infrared images.

The above approximation is especially effective for distant scenes or when the viewpoints of temporally adjacent images are close, which is almost always the case in a video. Specifically, our homographic transformation between two successive infrared images is represented by a 3×3 matrix H=[hᵢⱼ]. Using the matrix H, the motion of a tag between the two images is approximated as

$${x}^{′} = \frac{{h}_{11} x + {h}_{12} y + {h}_{13}}{{h}_{31} x + {h}_{32} y + {h}_{33}} , \\ {y}^{′} = \frac{{h}_{21} x + {h}_{22} y + {h}_{23}}{{h}_{31} x + {h}_{32} y + {h}_{33}} ,$$

where [x, y]^{T=} and [x′, y′]^{T} are the locations of the tags h₃₁ x+h₃₂ y+h₃₃

in the two images.

We estimate the homography between each pair of temporally adjacent color images. The estimation takes as input a set of correlated candidate tags extracted from the two infrared images. We obtain this set by applying a scale invariant feature transform (SIFT), Lowe, “Distinctive Image Features from Scale-Invariant Keypoints,” Int. J. on Computer Vision 60, 2, 91-110, 2004, incorporated herein by reference. The SIFT allows one to detect objects in a scene, which are subject to rotations, translations and/or distortions and partly lightening change. During each iteration, we use the 4-point inhomogeneous method to determine the homography.

Given the homography between all pairs of adjacent images, we can extend the tag correlation described above to videos acquired by moving cameras. For each tag a in the current image, we transform the tag to the next image using the estimated homography. The transformed tag is a. Then, we search for the tag a nearest to tag a in the next frame. If the distance between tag a and tag a is less than a threshold, we assume that the tags a and a are the same tag, and the code bit is “1”.

Otherwise, we set the code bit to ‘0 ’ for tag a in the next image. If there is any patch b in the next image that is not matched to a tag in the current image, then we treat it as a new tag with bit ‘0 ’ in the current image. In this case, we transform the location of tag b to the current image using the inverse of the homography between the two frames.

Automatic Retagging Changing Scenes

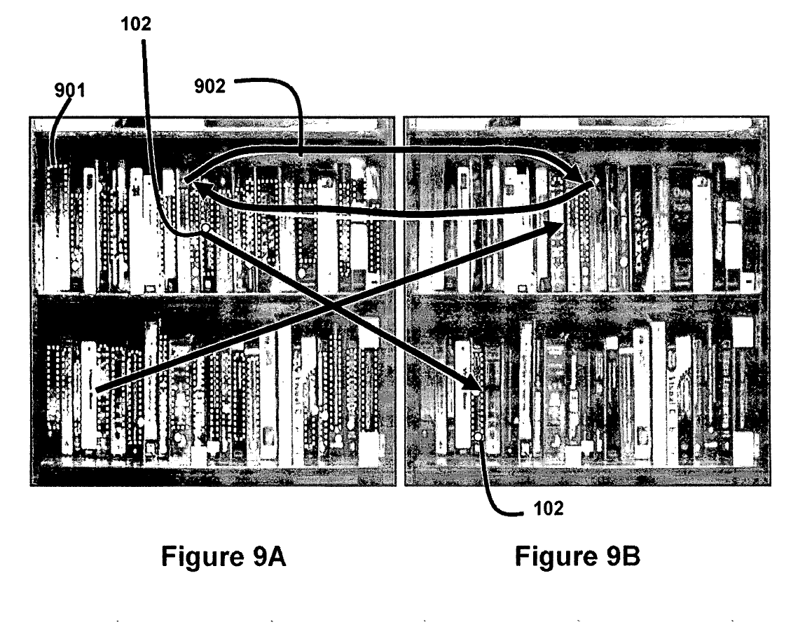

Thus far, we have assumed the tagged objects in the scene do not move. Although this assumption is valid for static scenes, e.g., museum galleries and furniture stores. Other scene as shown in FIGS. 9a and 9B, such as libraries, can include (occasionally) moving objects. To handle scenes with moving objects, we provide an appearance-based retagging method.

Each object (book) is assigned a tag 102 and an appearance feature, e.g., an rectangular outline 901 of some part of the object. In the example, the outline is on the spines of the books. If an object changes 902 location, then the system can detect the object at a new location according to its appearance, and the object can be retagged.

### EFFECT OF THE INVENTION

The invention provides a system and method for optically tagging objects in a scene so that objects can later be located in images acquired of the scene. Applications that can use the invention include browsing of photo collections, photo-based shopping, exploration of complex objects using augmented videos, and fast search for objects in complex scenes.

Although the invention has been described by way of examples of preferred embodiments, it is to be understood that various other adaptations and modifications may be made within the spirit and scope of the invention. Therefore, it is the object of the appended claims to cover all such variations and modifications as come within the true spirit and scope of the invention.

We claim:

1. A method for marking a scene and images acquired of the scene with tags, comprising:
projecting a set of tags into a scene while modulating an intensity of each tag according to a unique temporally varying code, and in which each tag is projected as an infrared signal at a known location in the scene;
acquiring a sequence of infrared images and a sequence of color images of the scene while performing the projecting and the modulating;
detecting a subset of the tags in the sequence of infrared images; and
displaying the sequence of color image while marking a location of each detected tag in the displayed sequence of color images, in which the marked location of the detected tag corresponds to the known location of the tag in the scene.

2. The method of claim 1, in which the sequence of infrared images is acquired by an infrared camera and the sequence of color images is acquired by a color camera, and optical centers of the infrared camera and the color cameras are co-located.

3. The method of claim 1, in which the sequence of infrared images and the sequence of color images are acquired by a hybrid camera having a single optical center.

4. The method of claim 1, further comprising:
associating a description with each tag; and
displaying the description of a selected tag while displayed the sequence of color images.

5. The method of claim 1, further comprising:
searching images stored in a database using the detected tags.

6. The method of claim 1, in which the intensity is a binary pattern of zeroes and ones.

7. The method of claim 6, further comprising:
limiting a maximum number of consecutive zeros and a maximum number of ones in the temporally varying code.

8. The method of claim 1, in which all circular shifts of the temporally varying code represent the identical temporally varying code.

9. The method of claim 1, further comprising:
acquiring an initial color image of the scene using the color camera;
displaying the initial color image; and
selecting the set of the tags in the displayed initial color image.

10. The method of claim 1, in which the superimposed tags include visible, occluded and out-of-view tags, and the visible, occluded and out-of-view tags are displayed using different colors.

11. The method of claim 2, further comprising:
acquiring the sequence infrared images while the infrared camera is moving.

12. The method of claim 1, in which the scene includes an object, and the object is associated with one of the set of tags;
moving the object; and
retagging the object automatically after moving the object.

13. The method of claim 1, further comprising:
acquiring the sequence of color images from arbitrary points of view.

14. The method of claim 1, in which a size of each tag corresponds approximately on pixel in one of the color images.

15. A system for marking a scene and images acquired of the scene with tags, comprising:
a projector configured to project a set of tags into a scene while modulating an intensity of each tag according to a unique temporally varying code, in which each tag is projected as an infrared signal at a known location in the scene;
a camera configured to acquire a sequence of infrared images and a sequence of color images of the scene while performing the projecting and the modulating;
means for detecting a subset of the tags in the sequence of infrared images; and
a display device configured to display the sequence of color image while marking a location of each detected tag in the displayed sequence of color images, in which the marked location of the detected tag corresponds to the known location of the tag in the scene.
